(19) United States
(12) Patent Application Publication
(10) Pub. No.: US 2018/0161811 A1
(43) Pub. Date: Jun. 14, 2018

(54) STAIN-PROOF COATING COMPOSITION, METHOD OF FORMING STAIN-PROOF COATING LAYER, AND METHOD OF PRODUCING CERAMIC BUILDING MATERIAL

(71) Applicant: NIPPON PAINT INDUSTRIAL COATINGS CO., LTD., Tokyo (JP)

(72) Inventors: Yoshito HIRAI, Osaka-shi, Osaka (JP); Arata SEKINE, Osaka-shi, Osaka (JP); Seigo MIYAZOE, Osaka-shi, Osaka (JP)

(73) Assignee: NIPPON PAINT INDUSTRIAL COATINGS CO., LTD., Tokyo (JP)

(21) Appl. No.: 15/554,569

(22) PCT Filed: Feb. 17, 2017
(86) PCT No.: PCT/JP2017/005800

§ 371 Date: Aug. 30, 2017

(30) Foreign Application Priority Data
Mar. 15, 2016 (JP) 2016-051012

(51) Int. Cl. B05D 5/08; C08K 3/22; B05D 7/24; C09D 201/04

(52) U.S. Cl. CPC B05D 5/083; C08K 3/22; C09D 5/1625; C09D 201/04; B05D 7/24

(57) ABSTRACT

The present invention provides a stain-proof coating composition including silica fine particles (A), a nonionic surfactant (B), and a nonionic surfactant (C), wherein the nonionic surfactant (B) is at least one kind of nonionic surfactant (B) selected from the group consisting of an acetylenediol-based surfactant (b-1) and a polyoxyalkylene alkyl ether-based surfactant (b-2), the nonionic surfactant (C) is at least one kind of nonionic surfactant (C) selected from the group consisting of a vinyl-based polymeric surfactant (c-1) and a polyoxyalkylene fatty acid ester-based surfactant (c-2).

### FIELD OF THE INVENTION

The present invention relates to a stain-proof coating composition, a method of forming a stain-proof coating layer using the same, and a method of producing a ceramic building material.

### BACKGROUND OF THE INVENTION

In recent years, there has been provided a building material having stain-proof properties prepared by applying a stain-proof coating composition onto the surface of a building material such as an exterior wall material to form a stain-proof coating layer. Furthermore, as an example of the building material having stain-proof properties, there has been provided a building material having a self-cleaning function.

In this context, for example, the self-cleaning function means a function by which, when a stain-proof coating layer having hydrophilicity is in a state of allowing a stain component to stick thereto and rainwater and the like continuously stick to the stain-proof coating layer, rainwater is allowed to enter the clearance between the stain component and the stain-proof coating layer and the stain component is removed together with rainwater.

For example, in the above-mentioned stain-proof coating composition, an aqueous dispersion liquid of silica fire particles and the like are included.

When a stain-proof coating composition containing silica fine particles is applied onto the surface of a coating film of an exterior wall material or the like, on the surface of the above-mentioned coating film, a super-hydrophilic stain-proof coating layer including silica fine particles is formed. Such a stain-proof coating layer enables antistaining utilizing the self-cleaning function described above to be realized.

Patent Document 1 (JP 2011-213810 A), Patent Document 2 (JP 2012-177062 A), and Patent Document 3 (JP 2013-81941 A) disclose a stain-proof paint composition including colloidal silica, a nonionic surfactant, and water.

Patent Document 4 (JP 2013-209832 A) discloses a constructional board having a clear coating film formed from a clear paint composition containing a fluorine-containing surfactant and an overcoat coating film layer by which the surface of the coating film is imparted with hydrophilicity.

Patent Document 1: JP 2011-213810 A

Patent Document 2: JP 2012-177062 A

Patent Document 3: JP 2013-81941 A

Patent Document 4: JP 2013-209832 A

### DISCLOSURE OF THE INVENTION

### Problems to be Solved by the Invention

In order to enhance the stain-proof performance, a stain-proof coating layer formed from a conventional stain-proof coating composition has been required to be thickened in film thickness of the coating layer, namely, be increased in content of silica fine particles as much as possible. However, when a stain-proof coating layer is thickened in film thickness, the layer is not desirable from the viewpoints of the lowering in appearance of a coating film, the occurrence of a crack in a coating film, the economy, and the like.

Furthermore, in stain-proof coating layers formed from stain-proof coating compositions shown in Patent Documents 1 to 4, there have been problems that moisture is allowed to infiltrate into the stain-proof coating layer, the change in refractive index due to moisture transport in and out of the coating film and bleed-out of a coating film component is caused, and the hue of the coating film varies with time. In the case where hue of the coating film varies and hue stability of the coating film is insufficient as described above, there have occurred problems such that a sense of incongruity is caused at the time when coated plates as products are arranged side by side and a partial repaired portion is liable to become conspicuous.

As described above, a stain-proof coating composition with which a stain-proof coating layer achieving both excellent stain-proof properties and excellent hue stability can be formed has still been required.

The present invention has been made in view of the above-mentioned circumstances and is aimed at providing a stain-proof coating composition with which a stain-proof coating layer having excellent stain-proof properties and hue stability can be formed. Furthermore, the present invention is aimed at providing a method of forming a stain-proof coating layer having such characteristics and a method of producing a ceramic building material using the same.

### Means for Solving the Problems

In order to solve the above-mentioned problems, the present invention provides the following embodiments.

[1] A stain-proof coating composition, including silica fine particles (A), a nonionic surfactant (B), and a nonionic surfactant (C),

wherein the nonionic surfactant (B) is at least one kind of nonionic surfactant (B) selected from the group consisting of an acetylenediol-based surfactant (b-1) and a polyoxyalkylene alkyl ether-based surfactant (b-2),

the nonionic surfactant (C) is at least one kind of nonionic surfactant (C) selected from the group consisting of a vinyl-based polymeric surfactant (c-1) and a polyoxyalkylene fatty acid ester-based surfactant (c-2), and

a mass ratio ((B)/(C)) of the nonionic surfactant (B) to the nonionic surfactant (C) is 5/95 to 90/10.

[2] The stain-proof coating composition according to [1], further including titanium oxide.

[3] The stain-proof coating composition according to [1] or [2], having a surface tension of 25 to 40 mN/m.

[4] A method of forming a stain-proof coating layer, including a step of coating a material to be coated with the stain-proof coating composition according to any one of [1] to [3] to form a stain-proof coating layer.

[5] The method of forming a stain-proof coating layer according to [4], wherein the material to be coated has at least one kind of coating film selected from an organic coating film, an inorganic coating film, an organic-inorganic hybrid coating film, and a fluororesin coating film, and the method includes a step of applying the stain-proof coating composition onto the coating film.

[6] A method of producing a ceramic building material, including a step of coating a material to be coated with the stain-proof coating composition according to any one of [1] to [3] to form a stain-proof coating layer.

The stain-proof coating composition of the present invention can be formed into a stain-proof coating layer having excellent stain-proof properties, and in addition, having hue stability.

### DETAILED DESCRIPTION OF THE PREFERRED EMBODIMENTS

[Stain-Proof Coating Composition]

A coating composition of the present invention is a stain-proof coating composition, including silica fine particles (A), a nonionic surfactant (B), and a nonionic surfactant (C),

wherein the nonionic surfactant (B) is at least one kind of nonionic surfactant (B) selected from the group consisting of an acetylenediol-based surfactant (b-1) and a polyoxyalkylene alkyl ether-based surfactant (b-2),

the nonionic surfactant (C) is at least one kind of nonionic surfactant (C) selected from the group consisting of a vinyl-based polymeric surfactant (c-1) and a polyoxyalkylene fatty acid ester-based surfactant (c-2), and

a mass ratio ((B)/(C)) of the nonionic surfactant (B) to the nonionic surfactant (C) is 5/95 to 90/10.

[Silica Fine Particles (A)]

For example, silica fine particles (A) in the present invention have an average primary particle diameter of 3 to 50 nm. The average primary particle diameter is preferably 10 to 25 nm and more preferably 10 to 15 nm. When the average primary particle diameter is less than 3 nm, the stain prevention effect may become insufficient and when being more than 50 nm, the appearance of a coating film may be deteriorated. Silica fine particles can be measured for the average primary particle diameter by a known measurement method such as electron microscope observation and the BET method (specific surface area method).

The content of silica fine particles (A) in a stain-proof coating composition of the present invention is preferably 0.1 to 5.0 parts by mass and more preferably 0.5 to 3.0 parts by mass relative to 100 parts by mass of the stain-proof coating composition. When being less than 0.1 parts by mass, there is a possibility that a sufficient stain-proof effect is not attained, and moreover, when being more than 5.0 parts by mass, the appearance of a coating film may be deteriorated, for example, the change in hue may become significant.

In this disclosure, the content of silica fine particles (A) means the solid content mass of silica fine particles (A) relative to the whole mass of the stain-proof coating composition.

As the silica fine particles (A), a suspension containing silica fine particles (A) (colloidal silica) can be used. The suspension containing silica fine particles (A) may be a suspension in which silica fine particles are stabilized in an acidic region or a basic region. Examples of a suspension containing silica fine particles (A) which are stable in an acidic region include a suspension from which sodium that is generally contained in a suspension containing silica fine particles is removed, a suspension in which silica fine particles are stabilized with an acid such as hydrochloric acid, sulfuric acid, phosphoric acid, and acetic acid. Examples of a suspension containing silica fine particles (A) which are stable in a basic region include a suspension in which silica fine particles are stabilized with a base such as ammonia, a sodium compound (for example, sodium hydroxide and the like), a potassium compound (for example, potassium hydroxide and the like), a calcium compound (for example, calcium hydroxide and the like), and aluminum hydroxide. Among these, only one kind of component can be used or plural kinds thereof can be used in combination.

With regard to a suspension in which silica fine particles (A) are stabilized in an acidic region, it is preferred that the pH lie within the range of 2.0 to 5.0 and it is more preferred that the pH lie within the range of 2.5 to 4.5. When the pH lies outside this range, the stability of silica fine particles (A) in the suspension may be impaired.

As a suspension in which silica fine particles (A) are stabilized in a basic region, it is more preferred that a suspension in which silica fine particles are stabilized without using a strongly basic compound may be used. More specifically, it is preferred that the pH of the suspension containing the silica fine particles (A) lie within the range of 8.0 to 11.0 and it is more preferred that the pH thereof lie within the range of 8.5 to 10.5. In the case where the pH lies outside the above-mentioned range, the stability of silica fine particles (A) in the suspension may be impaired.

Examples of such silica fine particles (A) (including ones in the form of a suspension of silica fine particles (A)) include the following commercially available products (each indicates a trade name) and the like. One kind of these may be used alone and two or more kinds thereof may be used in combination.

SNOWTEX^{(registered trademark)} 30, SNOWTEX^{(registered trademark)} 50, SNOWTEX^{(registered trademark)} N, SNOWTEX^{(registered trademark)} O, SNOWTEX^{(registered trademark)} C, SNOWTEX^{(registered trademark)} AK, SNOWTEX^{(registered trademark)} 20L, SNOWTEX^{(registered trademark)} N-40, SNOWTEX^{(registered trademark)} O-40, SNOWTEX^{(registered trademark)} OL, SNOWTEX^{(registered trademark)} MP-1040, SNOWTEX^{(registered trademark)} SS, SNOWTEX^{(registered trademark)} XS, SNOWTEX^{(registered trademark)} S, SNOWTEX^{(registered trademark)} 20, SNOWTEX^{(registered trademark)} 30, SNOWTEX^{(registered trademark)} 40 (available from Nissan Chemical Industries, Ltd.),

ADELITE AT-20, 30, 50, 20A, 30A, or 20Q (available from ADEKA CORPORATION),

CATALOID 350, 20H, 30, 30H, 40, 50, SA, or SN (available from Catalysts and Chemicals Industries Co., Ltd.),

SILICADOL 20, 30, or 40 (available from NIPPON CHEMICAL INDUSTRIAL CO., LTD.),

Syton^{(registered trademark)} X-30, D-30, or T-40 (available from DA NanoMaterials LLC),

LUDOX^{(registered trademark)} SM-30, L, HS-30, HS-40, TM, or AM (available from W.R. Grace & Co.), and

Nalcoag 1115, 1130, 1030, 1140, 1050, or 2327 (available from Katayama Nalco Inc.).

[Nonionic Surfactant (B)]

The stain-proof coating composition of the present invention includes a nonionic surfactant (B). By being made to include a nonionic surfactant (B), for example, satisfactory wettability of an aqueous stain-proof coating composition to a material to be coated or a coat thereof can be secured. The nonionic surfactant (B) is at least one kind of nonionic surfactant (B) selected from the group consisting of an acetylenediol-based surfactant (b-1) and a polyoxyalkylene alkyl ether-based surfactant (b-2).

The content of a nonionic surfactant (B) in a stain-proof coating composition of the present invention is preferably 0.02 to 5 parts by mass and more preferably 0.02 to 1 part(s) by mass relative to 100 parts by mass of the stain-proof coating composition. In the case where the content of a nonionic surfactant (B) is less than 0.02 parts by mass, a stain-proof coating composition fails to have a surface tension of 25 to 40 mN/m, and the stain-proof coating composition may fail to be uniformly applied onto a coat surface, thus, a portion having no stain-proof effect may be locally generated. Moreover, in the case where the content is more than 5 parts by mass, coating film performance may be lowered because the hydrophilicity brought about by silica fine particles may be inhibited. Furthermore, inhomogeneity of a stain-proof coating composition or a poor appearance of a coating film may be caused since the stain-proof coating composition becomes liable to foam on production and on application.

In the present application, for example, in the case where the nonionic surfactant (B) includes an acetylenediol-based surfactant (b-1) and a polyoxyalkylene alkyl ether-based surfactant (b-2), the total amount of the (b-1) component and the (b-2) component is adjusted to lie within the above-mentioned range relative to 100 parts by mass of the stain-proof coating composition.

The nonionic surfactant (B) preferably has an HLB of 12 or less and more preferably has an HLB of 4 to 12. In the present application, the HLB is an index for indicating the hydrophilic-lipophilic balance which is calculated from the formula of (Molecular Weight of Hydrophilic Moiety)/(Whole Molecular Weight) x 20 defined by the Griffin method.

By making the nonionic surfactant (B) have an HLB lying within such a range, wettability to an underlying material can be secured while suppressing foaming on production. In the present application, for example, in the case where the nonionic surfactant (B) includes an acetylenediol-based surfactant (b-1) and a polyoxyalkylene alkyl ether-based surfactant (b-2), the average of an HLB value of the (b-1) component and an HLB value of the (b-2) component is appropriately adjusted to lie within the above-mentioned range.

For example, an acetylenediol-based surfactant (b-1) in the present invention can be a surfactant having an acetylenediol unit (namely, having an acetylene bond and two hydroxyl groups simultaneously in one molecule) or a surfactant having an alkylene oxide unit and an acetylenediol unit. As such a surfactant, a commercially available product may be used. For example, Surfynol^{(registered trademark)} 104E, 420, 440, or 2502 and Dynol^{(registered trademark)} 604 or 607 (available from Air Products and Chemicals, Inc.), Olfine^{(registered trademark)} PD-001, PD-002W, PD-004, EXP. 4001, EXP. 4200, or EXP. 4300 (available from Nissin Chemical Industry Co., Ltd.), and the like can be used.

Examples of a polyoxyalkylene alkyl ether-based surfactant (b-2) in the present invention can include at least one of selected from a polyoxyethylene oleyl ether and a polyoxyethylene lauryl ether. As such a surfactant, a commercially available product may be used. For example, Newcol^{(registered trademark)} 2302, 2303, 2305, 1204, 1305, 2502-A, 2303-Y, 2304-YM, or 2304-Y (available from NIPPON NYUKAZAI CO., LTD.), EMULMIN^{(registered trademark)} 40, 50, or 70, SEDORAN^{(registered trademark)} FF-180 or SF-506, and NEWPOL^{(registered trademark)} PE-62, PE-64, PE-74, or PE-75 (available from Sanyo Chemical Industries, Ltd.), and the like can be used.

The above-mentioned nonionic surfactant (B) is at least one kind of nonionic surfactant (B) selected from the group consisting of an acetylenediol-based surfactant (b-1) and a polyoxyalkylene alkyl ether-based surfactant (b-2), and preferably, the nonionic surfactant (B) is an acetylenediol-based surfactant (b-1) or a polyoxyalkylene alkyl ether-based surfactant (b-2).

In the present application, the nonionic surfactant (B) can be appropriately selected depending on the kind of a surfactant used as a nonionic surfactant (C) described below.

[Nonionic Surfactant (C)]

The stain-proof coating composition of the present invention includes a nonionic surfactant (C). The nonionic surfactant (C) is at least one kind of nonionic surfactant

(C) selected from the group consisting of a vinyl-based polymeric surfactant (c-1) and a polyoxyalkylene fatty acid ester-based surfactant (c-2).

The nonionic surfactant (C) preferably has an HLB of 12 to 20 and more preferably has an HLB of 12 to 17. By making the nonionic surfactant (C) have an HLB lying within such a range, in cooperation with silica fine particles (A), the nonionic surfactant (C) can impart an excellent stain-proof effect to a stain-proof coating layer formed from the stain-proof coating composition of the present invention.

In the present application, for example, in the case where the nonionic surfactant (C) includes a vinyl-based polymeric surfactant (c-1) and a polyoxyalkylene fatty acid ester-based surfactant (c-2), the average of an HLB value of the vinyl-based polymeric surfactant (c-1) component and an HLB value of the polyoxyalkylene fatty acid ester-based surfactant (c-2) component is appropriately adjusted to lie within the above-mentioned range.

The content of the surfactant (C) in a stain-proof coating composition of the present invention is preferably 0.02 to 5 parts by mass and more preferably 0.02 to 3 parts by mass relative to 100 parts by mass of the stain-proof coating composition. In the case where the content of the surfactant (C) is less than 0.02 parts by mass, a sufficient stain-proof effect may fail to be attained. Moreover, when the content is more than 5 parts by mass, inhomogeneity of a stain-proof coating composition or a poor appearance of a coating film may be caused since the stain-proof coating composition may become liable to foam on production.

In the present application, for example, in the case where the nonionic surfactant (C) includes a vinyl-based polymeric surfactant (c-1) and a polyoxyalkylene fatty acid ester-based surfactant (c-2), the total amount of the vinyl-based polymeric surfactant (c-1) component and the polyoxyalkylene fatty acid ester-based surfactant (c-2) component is appropriately adjusted to lie within the above-mentioned range relative to 100 parts by mass of the stain-proof coating composition.

For example, as a vinyl-based polymeric surfactant (c-1) in the present invention, PITZCOL^{(registered trademark)} K-30, K-30L, K-90, K-90L, or V-7154 (available from DKS Co., Ltd.) can be used.

Examples of a polyoxyalkylene fatty acid ester-based surfactant (c-2) in the present invention include IONET^{(registered trademark)} MS-400, MS-1000, MO-600, DS-4000, or DO-1000 (available from Sanyo Chemical Industries, Ltd.).

The above-mentioned nonionic surfactant (C) is at least one kind of nonionic surfactant (C) selected from the group consisting of a vinyl-based polymeric surfactant (c-1) and a polyoxyalkylene fatty acid ester-based surfactant (c-2), and preferably, the nonionic surfactant (C) is a vinyl-based polymeric surfactant (c-1) or a polyoxyalkylene fatty acid ester-based surfactant (c-2).

In the present application, the nonionic surfactant (C) can be appropriately selected depending on the kind of a surfactant used as the above-mentioned nonionic surfactant (B).

As described above, in the stain-proof coating composition of the present invention, a mass ratio ((B)/(C)) of the nonionic surfactant (B) to the nonionic surfactant (C) is 5/95 to 90/10.

For example, in the stain-proof coating composition of the present invention, the mass ratio ((B)/(C)) of the nonionic surfactant (B) to the nonionic surfactant (C) is preferably 5/95 to 70/30.

In the case where the mass ratio of the nonionic surfactant (B) is lower than 5%, wettability of a stain-proof coating composition to an underlying material becomes insufficient and the stain-proof coating composition may fail to be uniformly applied. Moreover, in the case where the mass ratio of the nonionic surfactant (C) is lower than 10%, a sufficient stain-proof effect may be not attained.

Making a stain-proof coating composition of the present invention include a nonionic surfactant (B) and a nonionic surfactant (C) at the above-mentioned mass ratio ((B)/(C)) enables the stain-proof coating composition to be formed into a stain-proof coating layer having excellent stain-proof properties, and in addition, having excellent hue stability. Furthermore, the stain-proof coating layer formed from the stain-proof coating composition of the present invention can be thinned in its layer thickness, can retain excellent hydrophilicity over a long period of time, and can achieve both wettability to an underlying material and stain-proof properties.

Moreover, making a mass ratio ((B)/(C)) of the nonionic surfactant (B) to the nonionic surfactant (C) lie within the above-mentioned range enables the content of silica fine particles (A) included in the stain-proof coating composition of the present invention to be greatly reduced as compared with a known stain-proof coating composition. For example, the content of silica fine particles (A) in the stain-proof coating composition of the present invention can be reduced to two-thirds or less of the content of silica fine particles in a known stain-proof coating composition. Besides, the change in hue with time of the stain-proof coating layer formed from the stain-proof coating composition can be reduced.

Furthermore, by using the nonionic surfactant (B) and the nonionic surfactant (C) under the above-mentioned conditions in the present invention, the stain-proof coating layer formed from the stain-proof coating composition can exert an excellent self-cleaning function, even if dust existing in the atmosphere sticks thereto, while suppressing adhesion of a stain existing in the atmosphere.

For example, the mass ratio ((B)/(C)) of the nonionic surfactant (B) to the nonionic surfactant (C) may be roughly 1:1 and the mass ratio ((B)/(C)) of the nonionic surfactant (B) to the nonionic surfactant (C) may be 55/45 to 45/55. Making a stain-proof coating composition include a nonionic surfactant (B) and a nonionic surfactant (C) within such a range enables a stain-proof coating layer formed from the stain-proof coating composition to have strong hydrophilicity while maintaining the wettability to an underlying material.

Moreover, in the stain-proof coating composition, the blending amount of a nonionic surfactant (B) may be greater than the blending amount of a nonionic surfactant (C) as long as the mass ratio ((B)/(C)) lies within the above-mentioned range, and vice versa.

The total amount of a nonionic surfactant (B) and a nonionic surfactant (C) is preferably 0.1 to 6.0 parts by mass and more preferably 0.3 to 3.0 parts by mass relative to 100 parts by mass of the stain-proof coating composition. In the case where the total of a nonionic surfactant (B) and a nonionic surfactant (C) is less than 0.1 parts by mass, wettability to an underlying material may become insufficient and sufficient stain-proof performance may be not attained. Moreover, in the case where the total amount is greater than 6.0 parts by mass, inhomogeneity of a stain-proof coating composition or a poor appearance of a coating film may be caused since the stain-proof coating composition may become liable to foam on production and on application.

In the present invention, the combination of a nonionic surfactant (B) and a nonionic surfactant (C) is not particularly limited as long as the mass ratio thereof lies within the above-mentioned range. For example, an acetylenediol-based surfactant (b-1) and a vinyl-based polymeric surfactant (c-i) may be used as the nonionic surfactant (B) and the nonionic surfactant (C), respectively. Even if any combination thereof is adopted, the stain-proof coating composition of the present invention has excellent stain-proof properties and excellent hue stability.

By using the nonionic surfactant (B) and the nonionic surfactant (C) together under the above-mentioned conditions in the present invention, it is possible to make the contact angle with water on the surface of a stain-proof coating layer less than 30 degrees. The contact angle with water on the surface thereof is preferably less than 25 degrees. By making the contact angle with water on the surface thereof less than 30 degrees, the stain-proof coating layer can be imparted with stronger hydrophilicity and the stain-proof coating layer can have satisfactory stain-proof properties by virtue of the self-cleaning function.

In the present specification, the measurement of a contact angle with water on the coating film is performed that 4 μL of pure water is dripped on a coating film surface to determine a contact angle with water on the coating film as an angle formed by a tangential line of a liquid droplet and the solid surface. Moreover, the measurement of a contact angle with water is performed by a θ/2 method.

In the present specification, having excellent hue stability means having a small variation width of hue with the lapse of time. A coating film formed from the stain-proof coating composition of the present invention has a small variation width of hue, that is, has excellent hue stability. More specifically, when a hue value of a stain-proof coating layer that is formed from the stain-proof coating composition and subjected to aging at room temperature for 4 days, which is set as an initial value, is compared with a hue value of a stain-proof coating layer after subjected to an accelerated weathering test for approximately 100 hours, the hue difference (ΔL) calculated lies within the range of 0 to about −0.5.

For example, the stain-proof coating composition of the present invention has a surface tension of 25 to 40 mN/m and preferably has a surface tension of 25 to 35 mN/m.

In the case where the surface tension of a stain-proof coating composition is larger than 40 mN/m, the stain-proof coating composition may fail to be uniformly applied onto a coat surface and a portion having no stain-proof effect may be locally generated. Moreover, by making a stain-proof coating composition have a surface tension lying within the above-mentioned range, for example, it becomes possible to uniformly apply the stain-proof coating composition of the present invention also onto various coat surfaces such as the surface of a coat having a property which repels aqueous liquid without being added with an organic solvent such as a kind of alcohol.

In the present application, for example, a stain-proof coating liquid of the present invention is measured for the surface tension according to a method described in “Current Instrumental Analysis for Colour Material and Polymers—Analysis and Physical Property Evaluation—” (published by Soft Science Inc., edited by Japan Society of Colour Material, Editor-in-chief Yoshinori Hoshino, p. 289 Surface Tension Measurement Method, “Du Nouy Ring method”).

Furthermore, the stain-proof coating composition of the present invention can include an additional nonionic surfactant in addition to the nonionic surfactant (B) and the nonionic surfactant (C) mentioned above. For example, a silicon-based surfactant, a fluorine-based surfactant, and the like can be included therein. The silicon-based surfactant and the fluorine-based surfactant mentioned above may be used in combination and these surfactants may be used alone. The content of these additional nonionic surfactants is preferably less than 1.0 part by mass relative to 100 parts by mass of the stain-proof coating composition. In the present application, the nonionic surfactant other than the nonionic surfactant (B) and the nonionic surfactant (C) mentioned above can be added without departing from the scope of the present invention.

Examples of the silicon-based surfactant can include Guranoru^{(registered trademark)} 100, 400, or 440, POLYFLOW^{(registered trademark)} KL-245, KL-270, KL-280, or KL-600 (available from Kyoeisha Chemical Co., Ltd.), BYK-307, 333, 345, 346, 348, 375, or 378 (available from BYK Japan KK), and SN WET^{(registered trademark)} 125 or 126 (available from SAN NOPCO LIMITED).

Examples of the fluorine-based surfactant can include FTERGENT^{(registered trademark)} 250, 251, 222F, or 208G (available from NEOS COMPANY LIMITED), Megaface^{(registered trademark)} F-443, F-444, F-445, F-470, F-471, F-475, F-477, or F-479 (available from DIC Corporation), NOVEC FC-4430 or 4432 (available from 3M Limited), UNIDYNE^{(registered trademark)} DS-401 or 403 (available from NISSHIN-KASEI CO., LTD.), and EF-TOP^{(registered trademark)} EF-121, EF-122A, EF-128B, or EF-122C (available from JEMCO INC.).

Furthermore, the stain-proof coating composition of the present invention can include a photocatalyst such as titanium oxide. For example, when the stain-proof coating composition includes titanium oxide, by virtue of a photocatalytic action thereof, a stain-proof coating layer formed from the stain-proof coating composition of the present invention can be added with a stain decomposing function and imparted with stronger hydrophilicity.

The titanium oxide preferably has an average particle diameter of not more than 120 nm. When the average particle diameter is more than 120 nm, a stain-proof coating layer may become white and cloudy since titanium oxide is originally a white pigment and is high in concealing properties. Moreover, since titanium oxide has a high specific gravity, in the case where titanium oxide with an average particle diameter exceeding the preferred average particle diameter is added, a precipitate may be generated during preservation of the stain-proof coating composition. The average particle diameter can be measured by a dynamic light scattering method utilizing a laser.

The content of a photocatalyst such as titanium oxide is preferably 0.005 to 2 parts by mass and more preferably 0.025 to 0.5 parts by mass relative to 100 parts by mass of the whole stain-proof coating composition.

Examples of the photocatalyst such as titanium oxide can include STS-01, STS-02, STS-21, STS-100, ST-01, ST-21, ST-31, or ST-30L (available from ISHIHARA SANGYO KAISHA, LTD.).

The stain-proof coating composition of the present invention preferably contains water. The content of water in the stain-proof coating composition of the present invention needs only to be adjusted so that the total of water and other components becomes 100 parts by mass. Moreover, as necessary, the composition may contain a kind of alcohol.

For example, optionally, the stain-proof coating composition of the present invention can include a pigment, an aggregate (sand or the like), a film-forming assistant, a drying-retarding assistant (drying retarder), a viscosity modifier, a preservative, an antifungal agent, a preservative, a defoaming agent, a light stabilizer, an oxidation inhibitor, an ultraviolet ray absorber, a pH adjusting agent, and the like.

The respective components mentioned above can be mixed by a known method to produce the stain-proof coating composition of the present invention.

[Formation of Stain-proof Coating Layer]

A base material onto which the stain-proof coating composition of the present invention is applied is not particularly limited and examples thereof can include a metallic base material, a plastic base material, an inorganic material-made base material, and the like. Moreover, in the present specification, such a base material is sometimes referred to as a material to be coated.

The above-mentioned metallic base material is not particularly limited and examples thereof can include an aluminum plate, an iron plate, a zinc-plated steel plate, an aluminum-zinc alloy plated steel plate, a stainless steel plate, a tinned plate, and the like. Examples of the above-mentioned plastic base material can include an acrylic plate, a polyvinyl chloride plate, a polycarbonate plate, an ABS plate, a polyethylene terephthalate plate, a polyolefin plate, and the like. Examples of the above-mentioned inorganic material-made base material can include a ceramic-made base material, a glass-made base material, and the like described in JIS A 5422, JIS A 5430, and the like.

Among these, in the present invention, inorganic material-made base materials, in particular, building materials used for the wall surface of an interior wall, an exterior wall, or the like or the roof of buildings such as residential buildings and general buildings, ceramic building materials, and inorganic building materials made of concrete, ALC (autoclaved light-weight concrete), or any other inorganic building materials, are preferred and ceramic building materials are more preferred.

For example, the above-mentioned base material may be a cement siding material described in JIS A 5422, a fiber reinforced cement board described in JIS A 5430, and such a ceramic building material or board to be coated having at least one kind of coat selected from an organic coat, an inorganic coat, an organic-inorganic hybrid coat, or a fluororesin coat on the surface of thereof. Each of the organic coat, the inorganic coat, the organic-inorganic hybrid coat, and the fluororesin coat is not particularly limited. For example, such a coat can be a coat, which is referred to also as a primer, an enamel-based coat, a clear coat, or the like, prepared by applying a paint composition known in the art onto a base material and curing the paint composition to be formed.

The stain-proof coating composition of the present invention can also satisfactorily adhere to an organic coat, an inorganic coat, an organic-inorganic hybrid coat, or a fluororesin coat. With regard to such a property, by applying the stain-proof coating composition of the present invention onto the above-mentioned coating film to form a stain-proof coating layer, satisfactory appearance is brought about and the peeling of the stain-proof coating layer, the change in hue thereof, and the like can be suppressed. Furthermore, by using the stain-proof coating layer of the present invention, the chalking of an enamel-based coat or the like, the color fading thereof, and the like can also be suppressed.

The method for applying the stain-proof coating composition in the present invention is not particularly limited. Examples thereof can include generally used application methods such as an immersion method and a method of using a brush, a roller, a roll coater, an air spray coating apparatus, an airless spray coating apparatus, a curtain flow coater, a roller curtain coater, a die coater, or the like. The application method is appropriately selected depending on the kind of a base material or the use.

A stain-proof coating composition is applied under a condition where the dried film thickness preferably lies within the range of 50 nm to 5 μm and more preferably lies within the range of 50 nm to 1 μm. For example, the coating quantity of the stain-proof coating composition is to 50 g/m². As necessary, the stain-proof coating composition may be recoated thereon plural times. As necessary, a stain-proof coating layer obtained by applying the stain-proof coating composition is dried at ordinary temperature (ambient temperature), preferably at room temperature (23° C.) to 150° C., and preferably at 80° C. to 130° C. The drying time for a coating film obtained by applying the stain-proof coating composition is preferably 30 seconds to 10 minutes and more preferably 30 seconds to 5 minutes.

Furthermore, the present invention provides a method of producing a ceramic building material including the step of coating a material to be coated with the stain-proof coating composition of the present invention to form a stain-proof coating layer. The details of the material to be coated, the application condition, and the like are as defined above. Moreover, optionally, a material to be coated can have the above-mentioned coat.

It should be noted that the present invention is not limited to the above-mentioned embodiments, and modifications, alterations, and the like within the scope of the present invention are contemplated within the present invention.

### EXAMPLES

Hereinafter, the present invention will be described in more detail on the basis of examples, but the present invention is not limited to these examples. It should be noted that “parts” and “%” are on the basis of the mass unless otherwise stated.

### Example 1

### <Preparation of Stain-Proof Coating Composition>

As listed in Table 1A, 1.0 part by mass of silica fine particles (SNOWTEX N, Solid Content Concentration of 20%, Average Primary Particle Diameter of 10 to 15 nm), 0.05 parts by mass of a nonionic surfactant (B) (Surfynol 420 (available from Air Products and Chemicals, Inc.)), 0.3 parts by mass of a nonionic surfactant (C) (IONET DO-600 (available from Sanyo Chemical Industries, Ltd.)), and water were sequentially added and mixed with stirring, to prepare a stain-proof coating composition so that the whole amount was made up to 100 parts by mass with water and the above-mentioned components. The mass ratio ((B)/(C)) of the nonionic surfactant (B) to the nonionic surfactant (C) is shown in Table 1A. In these embodiments, blending amounts of the respective components each indicate the mass in terms of the solid content.

TABLE 1A

| | Silica Fine particles | | | | | | | Additional | |
|---|---|---|---|---|---|---|---|---|---|
| | (A) | | Surfactant (B) | | Surfactant (C) | | | Component | |
| | | Amount | | Amount | | Amount | | | Amount |
| | | (parts by | | (parts by | | (parts by | | | (parts by |
| | Kind | Mass) | Kind | Mass) | Kind | Mass) | (B)/(C) | Kind | Mass) |
| Example 1 | SNOWTEX N | 1.00 | Surfynol 420 | 0.05 | IONET MO-600 | 0.30 | 14/86 | | |
| Example 2 | SNOWTEX N | 1.00 | Surfynol 420 | 0.05 | PITZCOL K-30L | 0.30 | 14/86 | | |
| Example 3 | SNOWTEX N | 1.00 | Newcol 2303-Y | 0.10 | IONET MO-600 | 0.30 | 25/75 | | |
| Example 4 | SNOWTEX N | 1.00 | Newcol 2303-Y | 0.10 | PITZCOL K-30L | 0.30 | 25/75 | | |
| Example 5 | SNOWTEX N | 0.10 | Surfynol 420 | 0.05 | IONET MO-600 | 0.30 | 14/86 | | |
| Example 6 | SNOWTEX N | 5.00 | Surfynol 420 | 0.05 | IONET MO-600 | 0.30 | 14/86 | | |
| Example 7 | SNOWTEX C | 1.00 | Surfynol 420 | 0.05 | IONET MO-600 | 0.30 | 14/86 | | |
| Example 8 | SNOWTEX N | 1.00 | Surfynol 420 | 0.05 | IONET MO-600 | 0.30 | 14/86 | STS-21 | 0.10 |
| Example 9 | SNOWTEX N | 1.00 | Surfynol 420 | 5.00 | IONET MO-600 | 1.00 | 83/17 | | |
| Example 10 | SNOWTEX N | 1.00 | Surfynol 420 | 0.02 | IONET MO-600 | 0.10 | 17/83 | | |
| Example 11 | SNOWTEX N | 1.00 | Surfynol 420 | 1.00 | IONET MO-600 | 5.00 | 17/83 | | |
| Example 12 | SNOWTEX N | 1.00 | Surfynol 420 | 0.10 | IONET MO-600 | 0.02 | 83/17 | | |
| Example 13 | SNOWTEX N | 1.00 | Surfynol 420 | 0.50 | IONET MO-600 | 0.50 | 50/50 | | |
| Example 14 | SNOWTEX N | 1.00 | Surfynol 420 | 0.10 | IONET MO-600 | 1.90 | 5/95 | | |
| Example 15 | SNOWTEX N | 1.00 | Surfynol 420 | 1.80 | IONET MO-600 | 0.20 | 90/10 | | |
| Example 16 | SNOWTEX N | 1.00 | Surfynol 420 | 0.02 | IONET MO-600 | 0.30 | 14/86 | | |
| | | | Newcol 2303-Y | 0.03 | | | | | |
| Example 17 | SNOWTEX N | 1.00 | Surfynol 420 | 0.05 | IONET MO-600 | 0.15 | 14/86 | | |
| | | | | | PITZCOL K-30L | 0.15 | | | |

TABLE 1B

| | Silica Fine particles | | | | | | | Additional | |
|---|---|---|---|---|---|---|---|---|---|
| | (A) | | Surfactant (B) | | Surfactant (C) | | | Component | |
| | | Amount | | Amount | | Amount | | | Amount |
| | | (parts by | | (parts by | | (parts by | | | (parts by |
| | Kind | Mass) | Kind | Mass) | Kind | Mass) | (B)/(C) | Kind | Mass) |
| Comparative | SNOWTEX N | 1.00 | Surfynol 420 | 0.05 | — | — | 100/0 | | |
| Example 1 | | | | | | | | | |
| Comparative | SNOWTEX N | 1.00 | — | — | IONET MO-600 | 0.30 | 0/100 | | |
| Example 2 | | | | | | | | | |
| Comparative | SNOWTEX N | 1.00 | Surfynol 420 | 0.02 | IONET MO-600 | 1.98 | 1/99 | | |
| Example 3 | | | | | | | | | |
| Comparative | SNOWTEX N | 1.00 | Surfynol 420 | 1.90 | IONET MO-600 | 0.10 | 95/5 | | |
| Example 4 | | | | | | | | | |
| Comparative | SNOWTEX N | 1.00 | Surfynol 420 | 6.00 | IONET MO-600 | 6.00 | 50/50 | | |
| Example 5 | | | | | | | | | |
| Comparative | SNOWTEX N | 1.00 | Surfynol 420 | 0.05 | IONET MO-200 | 0.30 | 14/86 | | |
| Example 6 | | | | | | | | | |
| Comparative | SNOWTEX N | 0.05 | Surfynol 420 | 0.05 | IONET MO-600 | 0.30 | 14/86 | | |
| Example 7 | | | | | | | | | |
| Comparative | SNOWTEX N | 7.00 | Surfynol 420 | 0.05 | IONET MO-600 | 0.30 | 14/86 | | |
| Example 8 | | | | | | | | | |

<Production Example of Coated Plate having Stain-Proof Coating Layer>

Onto a siding board for a ceramic building material (available from NICHIHA CORPORATION), an aqueous silicon acrylic resin emulsion enamel paint (O-DE TIGHT 390; available from Nippon Paint Industrial Coatings Co., LTD.) was applied by an air spray so that the coating amount was 70 g/m² and dried for 10 minutes at 100° C. with the use of a jet dryer (wind velocity of 10 m/s) to form an enamel coating film.

Next, onto a surface of the enamel coating film, an aqueous silicon acrylic resin emulsion clear paint (O-DE TIGHT 235 CLEAR; available from Nippon Paint Industrial Coatings Co., LTD.) was applied by an air spray so that the coating amount was 70 g/m² and dried for 10 minutes at 100° C. with the use of a jet dryer (Wind Velocity of 10 m/s) to form a clear coating film. Thus, a coated siding board was obtained.

Furthermore, onto the clear coating film, a stain-proof coating composition obtained as above was applied by an air spray so that the coating amount was 35 g/m² and dried for 1 minute at 100° C. with the use of a jet dryer (wind velocity of 10 m/s) to form a stain-proof coating layer. Thus, a coated plate having a stain-proof coating layer was obtained. The stain-proof coating layer obtained was determined to have a thickness of 230 nm. After the application of the stain-proof coating composition, the coated plate was allowed to stand at room temperature for 1 day to be provided for a test described below.

The obtained coated plate having a stain-proof coating layer was evaluated for the following items. Results are shown in Table 2

(1) Foaming Tendency

The foam generation status at the time of preparing a stain-proof coating composition was visually evaluated according to the following criteria.

◯: The composition almost never foams.

Δ: The composition slightly foams.

×: The composition considerably foams.

(2) Surface State of Coating Film (State of Wet Coating Film)

At the time when a stain-proof coating composition was applied, the state of a wet coating film was visually evaluated according to the following criteria.

∘: The composition is uniformly applied.

Δ: The composition is uniformly applied, but unevenness is generated in the course of drying.

×: The composition is not uniformly applied.

(3) Contact Angle with Water on Coating Film

On a coating film surface, 4 μL of pure water was dripped to determine a contact angle with water as an angle formed by a tangential line of a liquid droplet and the solid surface. In the present application, a fully automated contact angle meter DropMaster 500 (available from Kyowa Interface Science Co., Ltd.) was used to perform the measurement of a contact angle with water by a 8/2 method.

(4) Stain-Proof Properties (Staining Test: Falling-Drop Method in Wet Process with Carbon Black Suspension Liquid)

On a surface of a horizontally arranged coated plate sprinkled with water by the use of a sprayer, approximately 0.5 ml of a dispersion liquid (staining liquid) prepared by dispersing 1 part by mass of hydrophobic carbon black [Carbon Black FW-200 (available from Evonik Degussa Co., Ltd.)] in 99 parts by mass of liquid paraffin was dripped by the use of a dropping pipet.

Next, the coated plate, on which the above-mentioned hydrophobic carbon black dispersion liquid was dripped, was made to vertically stand, tap water was sprayed thereto by the use of a sprayer within 10 seconds, and the spraying was continued for up to 60 seconds until no more stain was flushed away. The surface appearance of the coated plate after the completion of the test was visually evaluated according to the following criteria.

∘: The stain has been removed completely.

Δ: On a part of the coating film surface, a stained portion remains.

×: The stain is clearly observed.

(5) Hue Stability

A hue value of a coating film subjected to aging at room temperature for 4 days after the application of a stain-proof coating composition, which is set as an initial value, was compared with a hue value of a coating film after subjected to an accelerated weathering test for 100 hours using the Sunshine weather meter S80 (available from Suga Test Instruments Co., Ltd., Irradiance: 255 W/m²) being a sunshine carbon-arc lamp type accelerating weather meter stipulated in JIS B 7753 (ΔL). For the measurement of the hue, a chroma meter CR-400 (available from MINOLTA) was used.

(6) Surface Tension

A stain-proof coating composition was measured for the surface tension by the Du Nouy Ring Method (“Current Instrumental Analysis for Colour Material and Polymers—Analysis and Physical Property Evaluation—” published by Soft Science Inc., edited by Japan Society of Colour Material, p. 289, Surface Tension Measurement Method, “Du Nouy Ring Method”) with the use of a dynamic contact angle meter DCA100 (available from A&D Company, Limited) and a platinum-made ring.

TABLE 2A

| | | | Contact | | | |
|---|---|---|---|---|---|---|
| | | | Angle | | | |
| | | | with | | | |
| | | | Water | | | |
| | | Surface | on | | Hue | |
| | | State of | Coating | Stain- | Sta- | Surface |
| | Foaming | Coating | Film | proof | bil- | Tension |
| | Tendency | Film | (°) | Properties | ity | mN/m |
| Example 1 | ◯ | ◯ | 20 | ◯ | −0.4 | 27.7 |
| Example 2 | ◯ | ◯ | 23 | ◯ | −0.3 | 28.2 |
| Example 3 | ◯ | ◯ | 20 | ◯ | −0.3 | 26.7 |
| Example 4 | ◯ | ◯ | 23 | ◯ | −0.3 | 25.3 |
| Example 5 | ◯ | ◯ | 25 | ◯ | −0.4 | 27.5 |
| Example 6 | ◯ | ◯ | 18 | ◯ | −0.5 | 27.1 |
| Example 7 | ◯ | ◯ | 22 | ◯ | −0.4 | 27.6 |
| Example 8 | ◯ | ◯ | 18 | ◯ | −0.4 | 27.8 |
| Example 9 | ◯ | ◯ | 20 | ◯ | −0.3 | 25.1 |
| Example 10 | ◯ | ◯ | 20 | ◯ | −0.4 | 35.1 |
| Example 11 | ◯ | ◯ | 18 | ◯ | −0.4 | 26.1 |
| Example 12 | ◯ | ◯ | 23 | ◯ | −0.4 | 29.8 |
| Example 13 | ◯ | ◯ | 20 | ◯ | −0.4 | 25.7 |
| Example 14 | ◯ | ◯ | 20 | ◯ | −0.3 | 26.6 |
| Example 15 | ◯ | ◯ | 20 | ◯ | −0.4 | 25.3 |
| Example 16 | ◯ | ◯ | 21 | ◯ | −0.4 | 27.3 |
| Example 17 | ◯ | ◯ | 22 | ◯ | −0.3 | 27.0 |

TABLE 2B

| | | | Contact | | | |
|---|---|---|---|---|---|---|
| | | | Angle | | | |
| | | | with | | | |
| | | | Water | | | |
| | | Surface | on | | Hue | |
| | | State of | Coating | Stain- | Sta- | Surface |
| | Foaming | Coating | Film | proof | bil- | Tension |
| | Tendency | Film | (° C.) | Properties | ity | mN/m |
| Comparative | ◯ | ◯ | 30 | Δ | −0.4 | 28.3 |
| Example 1 | | | | | | |
| Comparative | ◯ | X | 40 | Δ | −0.5 | 47.8 |
| Example 2 | | | | | | |
| Comparative | ◯ | Δ | 25 | ◯ | −0.3 | 36.6 |
| Example 3 | | | | | | |
| Comparative | ◯ | ◯ | 30 | Δ | −0.3 | 23.9 |
| Example 4 | | | | | | |
| Comparative | X | ◯ | 20 | ◯ | −0.5 | 22.8 |
| Example 5 | | | | | | |
| Comparative | ◯ | ◯ | 25 | Δ | −0.4 | 28.4 |
| Example 6 | | | | | | |
| Comparative | ◯ | ◯ | 31 | Δ | −0.2 | 27.9 |
| Example 7 | | | | | | |
| Comparative | ◯ | ◯ | 18 | ◯ | −3.4 | 28.0 |
| Example 8 | | | | | | |

### Examples 2 to 17 and Comparative Examples 1 to 8

### <Preparation of Stain-Proof Coating Composition>

An aqueous stain-proof coating composition was prepared in the same manner as in Example 1 except for the formulation of the composition was set to that listed in the foregoing Table 1A and 1B.

More specifically, for example, 0.1 to 7.0 parts by mass of silica fine particles (A) (SNOWTEX N, SNOWTEX C (Solid Content Concentration of (20) %, Average Primary Particle Diameter of (10 to 15 nm)), a prescribed amount of a nonionic surfactant (B) [Surfynol 420 (available from Air Products and Chemicals, Inc.), Newcol 2303-Y (available from NIPPON NYUKAZAI CO., LTD.)], and a prescribed amount of a nonionic surfactant (C) [PITZCOL K-30L (DKS Co., Ltd.), IONET MO-600 (Sanyo Chemical Industries, Ltd.: HLB: 13.8 to 14.0), IONET MO-200 (Sanyo Chemical Industries, Ltd., HLB: 8.3 to 8.6)] and water were added so that the whole amount was made up to 100 parts by mass with water to prepare a stain-proof coating composition. Furthermore, in Example 8, 0.10 parts by mass of titanium oxide [STS-21 (available from ISHIHARA SANGYO KAISHA, LTD.)] was added thereto.

<Production of Coated Plate having Stain-Proof Coating Layer>

A coated plate was produced in the same manner as in Example 1 except for the formulation of the aqueous stain-proof coating composition was set to that listed in the foregoing Table 1A or 1B, provided for the above-mentioned test, and evaluated for the physical properties in the same manner as in Example 1 mentioned above. Evaluation results obtained are shown in Table 2A and 2B.

For example, the stain-proof coating layer in Example was determined to have a thickness of 230 nm and the stain-proof coating layer in Comparative Example 8 was determined to have a thickness of 1,610 nm.

According to the above-mentioned results, in Comparative Examples 1 and 2, the contact angle with water on the coating film is large, and moreover, the coating film is poor in stain-proof properties because a stain remains on a part of the coating film surface. Furthermore, in Comparative Example 2, at the time when a stain-proof coating composition was applied, a wet coating film failed to be uniformly formed. In addition, in Comparative Example 2, the surface tension is extremely high, and a stain-proof coating composition failed to be uniformly applied onto the surface of a coat having a property which repels aqueous composition. In Comparative Example 3, at the time when a stain-proof coating composition was applied, application unevenness was generated in the course of drying. In Comparative Example 4, the contact angle with water on the coating film is large, moreover, a stain remains on a part of the coating film surface, and the coating film is poor in stain-proof properties. In Comparative Example 5, at the time when a stain-proof coating composition was prepared, vigorous foaming has occurred. In Comparative Example 6, a stain remains on a part of the base material, and the coating film is poor in stain-proof properties. In Comparative Example 7, the contact angle with water on the coating film is large, a stain remains on a part of the coating film surface, and moreover, the coating film is poor in stain-proof properties. In Comparative Example 8, the coating film is significantly poor in hue stability.

### INDUSTRIAL APPLICABILITY

With the stain-proof coating composition according to the present invention, a stain-proof coating layer having various physical properties such as excellent stain-proof properties and hue stability can be formed. Moreover, the stain-proof coating layer can be thinned in thickness, and furthermore, the variation in hue with time can be reduced. In addition, the method of forming a stain-proof coating layer according to the present invention and the method of producing a ceramic building material using the same are applicable to general industrial application described above.

1. A stain-proof coating composition, comprising silica fine particles (A), a nonionic surfactant (B), and a nonionic surfactant (C),
wherein the nonionic surfactant (B) is at least one kind of nonionic surfactant (B) selected from the group consisting of an acetylenediol-based surfactant (b-1) and a polyoxyalkylene alkyl ether-based surfactant (b-2),
the nonionic surfactant (C) is at least one kind of nonionic surfactant (C) selected from the group consisting of a vinyl-based polymeric surfactant (c-1) and a polyoxyalkylene fatty acid ester-based surfactant (c-2), and
a mass ratio ((B)/(C)) of the nonionic surfactant (B) to the nonionic surfactant (C) is 5/95 to 90/10.

2. The stain-proof coating composition according to claim 1, further comprising titanium oxide.

3. The stain-proof coating composition according to claim 1, having a surface tension of 25 to 40 mN/m.

4. A method of forming a stain-proof coating layer, comprising a step of coating a material to be coated with the stain-proof coating composition according to claim 1 to form a stain-proof coating layer.

5. The method of forming a stain-proof coating layer according to claim 4, wherein
the material to be coated has at least one kind of coating film selected from an organic coating film, an inorganic coating film, an organic-inorganic hybrid coating film, and a fluororesin coating film, and
the method comprises a step of applying the stain-proof coating composition onto the coating film.

6. A method of producing a ceramic building material, comprising a step of coating a material to be coated with the stain-proof coating composition according to claim 1 to form a stain-proof coating layer.

7. The stain-proof coating composition according to claim 2, having a surface tension of 25 to 40 mN/m.

8. A method of forming a stain-proof coating layer, comprising a step of coating a material to be coated with the stain-proof coating composition according to claim 2 to form a stain-proof coating layer.

9. A method of forming a stain-proof coating layer, comprising a step of coating a material to be coated with the stain-proof coating composition according to claim 3 to form a stain-proof coating layer.

10. A method of producing a ceramic building material, comprising a step of coating a material to be coated with the stain-proof coating composition according to claim 2 to form a stain-proof coating layer.

11. A method of producing a ceramic building material, comprising a step of coating a material to be coated with the stain-proof coating composition according to claim 3 to form a stain-proof coating layer.
